(19) United States
(12) Patent Application Publication
(10) Pub. No.: US 2008/0068471 A1
(43) Pub. Date: Mar. 20, 2008

(54) Solid-state imaging apparatus

(75) Inventors: Toru Kondo, Tokyo (JP); Seisuke Matsuda, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/898,260

(22) Filed: Sep. 11, 2007

(30) Foreign Application Priority Data
Sep. 12, 2006 (JP) 2006-246544

(51) Int. Cl. H04N 5/76

(52) U.S. Cl. 348/231.99; 348/E05.031

(57) ABSTRACT

A solid-state imaging apparatus including: a pixel section having a plurality of pixel cells; a vertical signal line; a column signal processing circuit connected to the vertical signal line; a memory section for, during signal processing by the column signal processing circuit of the pixel cells of a first line, storing signal processing results of the pixel cells of a second line of which signal processing is executed previous to the first line; and a control section for rendering control so that, after causing each pixel cell to simultaneously reset, signal electric charges generated at each pixel cell are held simultaneously in all pixels and then sequentially outputted line by line of the pixel section to the vertical signal line, and the signal processing at the column signal processing circuit, a transfer to the memory section, and a readout from the memory section to an external device are then effected.

### BACKGROUND OF THE INVENTION

This application claims benefit of Japanese Patent Application No. 2006-246544 filed in Japan on Sep. 12, 2006, the contents of which are incorporated by this reference.

The present invention relates to solid-state imaging apparatus.

One for example disclosed in Japanese Patent Application Laid-Open 2005-51282 is known as a solid-state imaging apparatus which is configured to obtain imaging signals having less noise. FIG. 1 is a block diagram showing a general construction of the solid-state imaging apparatus disclosed in the publication. The solid-state imaging apparatus includes: a pixel cell 1 for converting optical signal into electrical signal; a pixel section 2 where pixel cells 1 are two-dimensionally arrayed; a vertical scanning section 3 for making a selection in vertical direction (pixel row) of the pixel section 2; a noise suppressing section 4 for suppressing noise of pixel signals from selected row; a horizontal select section 5 for selecting output signals of the noise suppressing section 4; a horizontal scanning section 6 for sequentially making a selection in horizontal direction of the horizontal select section 5; and a differential amplifier 7 for obtaining the differential of signals from the noise suppressing section 4.

A specific circuit construction and operation thereof will now be described by way of FIGS. 2 and 3 of the case where the pixel section 2 in the solid-state imaging apparatus having the above described construction is formed as a pixel array of 4 rows by 4 columns. Referring to the circuit diagram shown in FIG. 2, the pixel cell 1 includes: a photodiode PD for converting optical signal into electrical signal; an amplification transistor M3 for amplifying electric charge of photodiode PD; a transfer transistor M1 for transferring electric charge of photodiode PD to the gate of the amplification transistor M3; a reset transistor M2 for resetting the gate of the amplification transistor M3; and a select transistor M4. It should be noted that FD denotes a floating diffusion section which is formed at an input terminal (gate section) of the amplification transistor M3. The drains of the reset transistor M2 and the amplification transistor M3 are connected to a pixel power supply VDD, and the source of the select transistor M4 serves as a pixel output terminal and is connected to a vertical signal line 8.

The noise suppressing circuit 4 includes: a sampling transistor M11 for signal level; a sampling transistor M12 for reset level; a capacitor C11 for signal level; and a capacitor C12 for reset level. The horizontal select section 5 includes column select transistors M21 and M22. What is denoted by I1 is a current source which is a load on the vertical signal line 8.

An operation of the solid-state imaging apparatus having the above described construction will now be described by way of the timing chart shown in FIG. 3. First, transfer signals TX1 to TX4 and reset signals RS1 to RS4 are driven to H level so that reset operation of photodiode PD is effected through the transfer transistor M1 and reset transistor M2 within the pixel cell 1. Subsequently, an exposure of photodiode PD is started from a point in time (time point t1) when the transfer signals TX1 to TX4 are returned to L level. At this time, the exposure of photodiodes PD1 of all pixel cells 1 contained in the pixel section 2 are simultaneously started.

Subsequently, the reset signals RS1 to RS4 are returned to L level to end reset of the floating diffusion section FD. The completion of the exposure is effected by driving transfer signals TX1 to TX4 to H level again to transfer electric charge accumulated at photodiode PD to the floating diffusion section FD and subsequently by driving transfer signals TX1 to TX4 to L level at time point t2. At this time, the exposure of photodiodes PD of all pixel cells 1 contained in the pixel section 2 are simultaneously ended.

Next, a select signal SEL1 is driven to H level by the vertical scanning section 1 so that a first row of the pixel section is selected and a signal component Vsig of the first pixel row is outputted. At this time, a signal-level sample-and-hold signal SHS is set to H level, and subsequently the signal-level sample-and-hold signal SHS is brought to L level. The signal component Vsig is thereby retained at the signal level sampling capacitor C11 through the signal level sampling transistor M11.

Subsequently, the reset signal RS1 is driven to H level and then the reset signal RS1 is returned to L level to reset the floating diffusion section FD. A reset signal component Vrst of the first pixel row is thereby outputted.

At this time, a rest-level sample-and-hold signal SHN is set to H level, and subsequently the reset-level sample-and-hold signal SHN is brought to L level. The reset signal Vrst is thereby retained at the reset level sampling capacitor C12 through the reset level sampling transistor M12. Subsequently, the select signal SEL1 is brought to L level to end read operation and noise suppression of the pixel signals of the first row.

Finally, the horizontal select section 5 is selected sequentially in column direction by the horizontal scanning section 6. The signal component Vsig and reset component Vrst retained at the noise suppressing section 4 are thereby read out to the horizontal signal line 9 for signal and the horizontal signal line 10 for reset through the column select transistors M21 and M22. Difference signals (Vsig−Vrst) are then outputted to the outside of the solid-state imaging apparatus through the differential amplifier 7.

Here, even if a threshold variance Δ Vth, which is a characteristic difference of amplification transistor M3, occurs in the pixel output of each pixel cell, such threshold variance Δ Vth is contained in both the signal component Vsig and the reset component Vrst. For this reason, the threshold variance Δ Vth is canceled in the output of the differential amplifier 7. In a similar manner, read operation of the pixel signals and noise suppression operation, and the outputting operation to the outside are effected of the second to fourth rows.

### SUMMARY OF THE INVENTION

In a first aspect of the present invention, there is provided a solid-state imaging apparatus including: a pixel section having a plurality of pixel cells that are two-dimensionally arrayed, each having a photoelectric conversion section for generating signal electric charge corresponding to an object image, an electric charge transfer means for transferring the signal electric charge generated at the photoelectric conversion section, an amplification means for receiving at an input terminal thereof the electric charge transferred from the photoelectric conversion section by the electric charge transfer means and outputting a signal corresponding to the number of the electric charge at the input terminal, and a reset means for resetting the input terminal of the amplification means, where an output of the amplification means becoming an output signal of the pixel cell; a vertical signal line to which the output signal of the pixel cell is read out; a column signal processing circuit connected to the vertical signal line so as to effect analog signal processing on the output signal of the pixel cell; a memory section for, during signal processing by the column signal processing circuit of the pixel cells associated with a first line of the pixel section, storing signal processing results of the pixel cells associated with a second line of which signal processing by the column signal processing circuit is executed previous to the first line; and a control section for rendering control so that, after causing the reset means of each pixel cell of the pixel section to simultaneously operate, signal electric charges generated at the photoelectric conversion section of each pixel cell are transferred simultaneously of all pixels to the input terminal of the amplification means by the electric charge transfer means, output signals of the amplification means are then sequentially outputted line by line of the pixel section to the vertical signal line, and the signal processing at the column signal processing section and a transfer to the memory section are then effected of the output signals to the vertical signal line, and for rendering control of a readout from the memory section to an external device.

In a second aspect of the invention, the memory section in the solid-state imaging apparatus according to the first aspect has a capacity substantially equal to the number of all pixel cells of the pixel section.

In a third aspect of the invention, the memory section in the solid-state imaging apparatus according to the first aspect has a capacity smaller than the number of all pixel cells of the pixel section, and the control section renders control so that a storing operation of the signal processing results associated with the first line to the memory section from the column processing circuit, and a readout operation associated with the second line from the memory section to the external device are effected in parallel.

In a fourth aspect of the invention, the memory section in the solid-state imaging apparatus according to any one of the first to third aspects is composed of a first memory section disposed on one side of the pixel section and a second memory section disposed on the other side in a manner placing the pixel section between; the vertical signal line is composed of a first vertical signal line to which the pixel cells of first pixel rows of the pixel section are connected and a second vertical signal line to which the pixel cells of second pixel rows of the pixel section different from the first pixel rows are connected; the column signal processing circuit is composed of a first column signal processing circuit connected between the first vertical signal line and the first memory section, and a second column signal processing circuit connected between the second vertical signal line and the second memory section; and the control section renders control so that the output signals from the pixel section are read out line by line simultaneously to the first and the second vertical signal lines, are processed at the first and the second column signal processing circuits, and are transferred line by line simultaneously to the first and the second memory sections.

In a fifth aspect of the invention, the memory section in the solid-state imaging apparatus according to any one of the first to fourth aspects is covered with a metal wiring layer over an entire region thereof.

### BRIEF DESCRIPTION OF THE DRAWINGS

FIG. 1 is a block diagram showing a general construction of prior-art solid-state imaging apparatus.

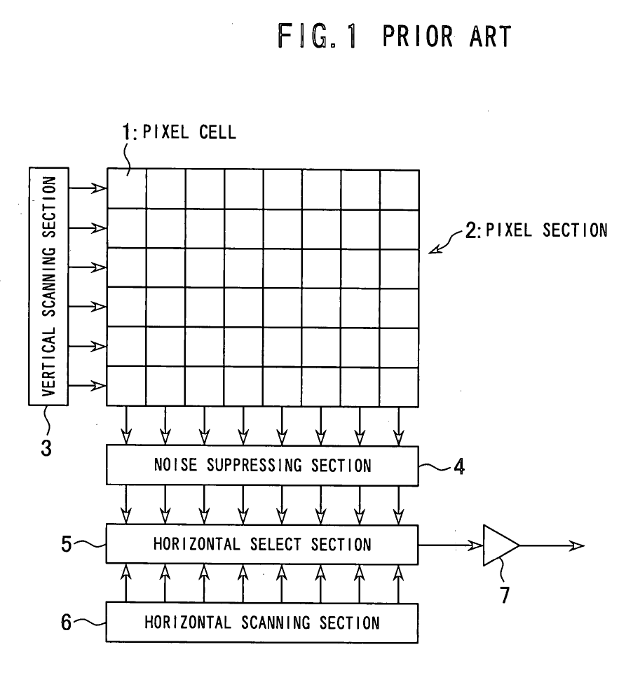

FIG. 2 is a block diagram showing a specific construction of the case where the pixel section in the solid-state imaging apparatus shown in FIG. 1 is formed as a pixel array of 4 rows by 4 columns.

FIG. 3 is a timing chart for explaining operation of the solid-state imaging apparatus shown in FIG. 2.

FIG. 4 is a block diagram showing a general construction of a first embodiment of the solid-state imaging apparatus according to the invention.

FIG. 5 is a block diagram showing a specific construction of the case where the pixel section in the first embodiment shown in FIG. 4 is formed as a pixel array of 4 rows by 4 columns.

FIG. 6 is a timing chart for explaining operation of the solid-state imaging apparatus according to the first embodiment shown in FIG. 5.

FIG. 7 is a block diagram showing construction of the solid-state imaging apparatus according to a second embodiment of the invention.

FIG. 8 is a timing chart for explaining operation of the solid-state imaging apparatus according to the second embodiment shown in FIG. 7.

FIG. 9 is a block diagram showing a general construction of the solid-state imaging apparatus according to a third embodiment of the invention.

FIG. 10 is a block diagram showing a specific construction of the case where the pixel section in the third embodiment shown in FIG. 9 is formed as a pixel array of 4 rows by 4 columns.

FIG. 11 is a timing chart for explaining operation of the solid-state imaging apparatus according to the third embodiment shown in FIG. 10.

FIG. 12 is a circuit diagram showing a modification of construction of the pixel cell of the pixel section.

FIG. 13 is a timing chart for explaining operation in the case where pixel cells of the construction shown in FIG. 12 are used in the third embodiment shown in FIG. 10.

### DESCRIPTION OF THE PREFERRED EMBODIMENTS

Some embodiments of the solid-state imaging apparatus according to the invention will be described below with reference to the drawings.

### Embodiment 1

A first embodiment of the solid-state imaging apparatus according to the invention will now be described.

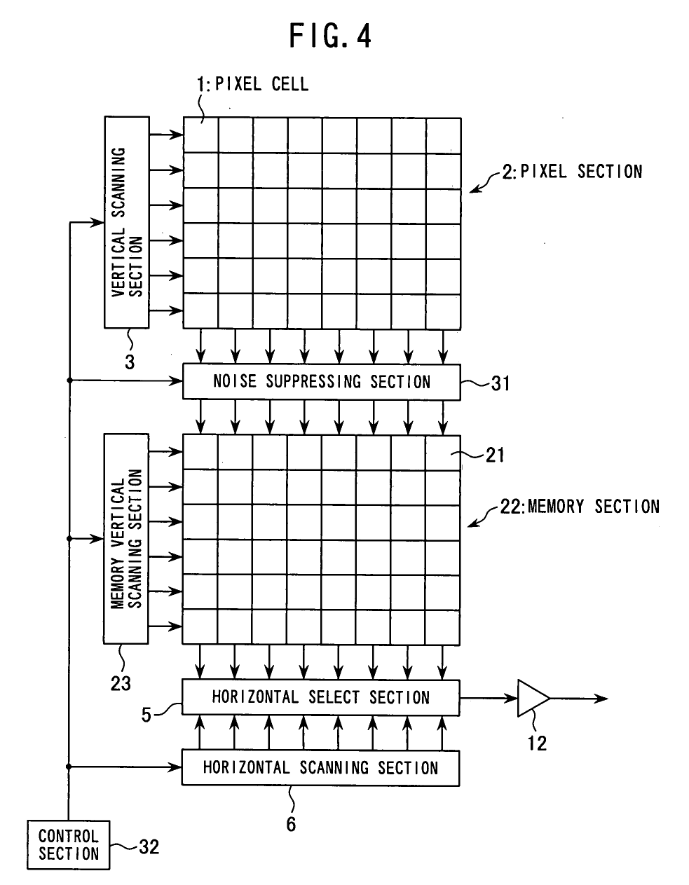

FIG. 4 is a block diagram showing a general construction of the solid-state imaging apparatus according to the first embodiment. The solid-state imaging apparatus according to this embodiment as shown in FIG. 4 includes: a pixel cell 1 for converting optical signal into electrical signal; a pixel section 2 where pixel cells 1 are two-dimensionally arrayed; a vertical scanning section 3 for selecting in vertical direction (rows) of the pixel section 2; a noise suppressing section 31 for suppressing noise of the pixel signals from selected row; a memory section 22 where memory cells 21 for accumulating output signal of the noise suppressing section 31 are two-dimensionally arrayed; a vertical scanning section 23 for memory for selecting in a vertical direction (memory rows) of the memory section 22; a horizontal select section 5 for selecting signals of a selected memory row; a horizontal scanning section 6 for selecting the horizontal select section 5 sequentially along the horizontal direction; an output amplifier 12; and a control section 32 for controlling operation of each section of the vertical scanning section 3, noise suppressing section 31, memory vertical scanning section 23, and horizontal scanning section 6.

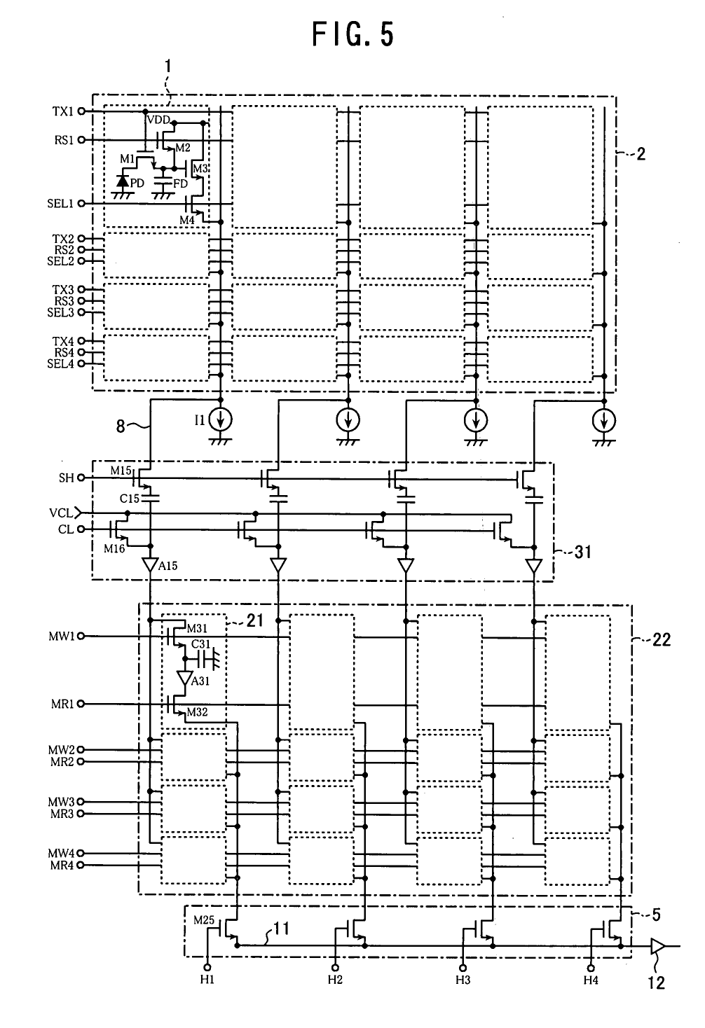

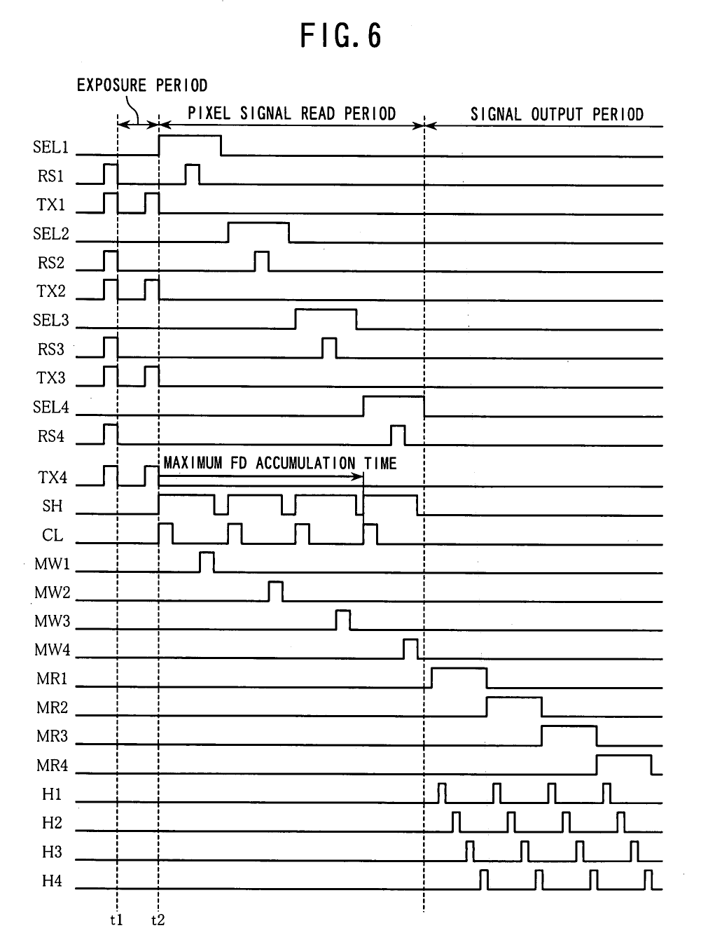

A specific circuit construction and operation thereof will be described below by way of FIGS. 5 and 6 of the case where the pixel section 2 in the solid-state imaging apparatus according to the first embodiment having the above construction is formed as a pixel array of 4 rows by 4 columns. Referring to a circuit diagram shown in FIG. 5, the pixel cell 1 includes: a photodiode PD for converting optical signal into electrical signal; an amplification transistor M3 for amplifying electric charge of photodiode PD; a transfer transistor M1 for transferring electric charge of photodiode PD to gate of the amplification transistor M3; a reset transistor M2 for resetting gate of the amplification transistor M3; and a select transistor M4. What is denoted by FD is a floating diffusion section which is formed at an input terminal (gate section) of the amplification transistor M3. The drains of the reset transistor M2 and the amplification transistor M3 are connected to a pixel power supply VDD, and the source of the select transistor M4 serves as a pixel output terminal and is connected to a vertical signal line 8.

The noise suppressing section 31 includes a sampling transistor M15, clamping transistor M16, clamp capacitor C15, and column amplifier A15. What is denoted by VCL is a clamp voltage connected to one end of the clamping transistor M16. A memory cell 21 includes: a memory capacitor C31 for accumulating output signal of the noise suppressing section 31; a memory write transistor M31 for writing to the memory capacitor C31; an amplifier A31 for memory for amplifying signal accumulated at the memory capacitor C31; and a memory read transistor M32 for reading output of the memory amplifier A31. The horizontal select section 5 includes a column select transistor M25. What is denoted by I1 is a current source which is a load on the vertical signal line 8.

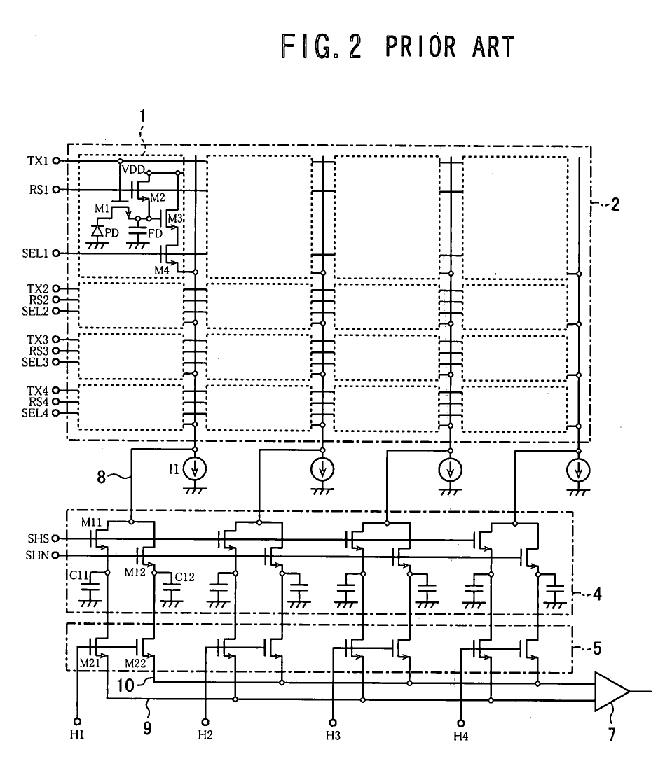

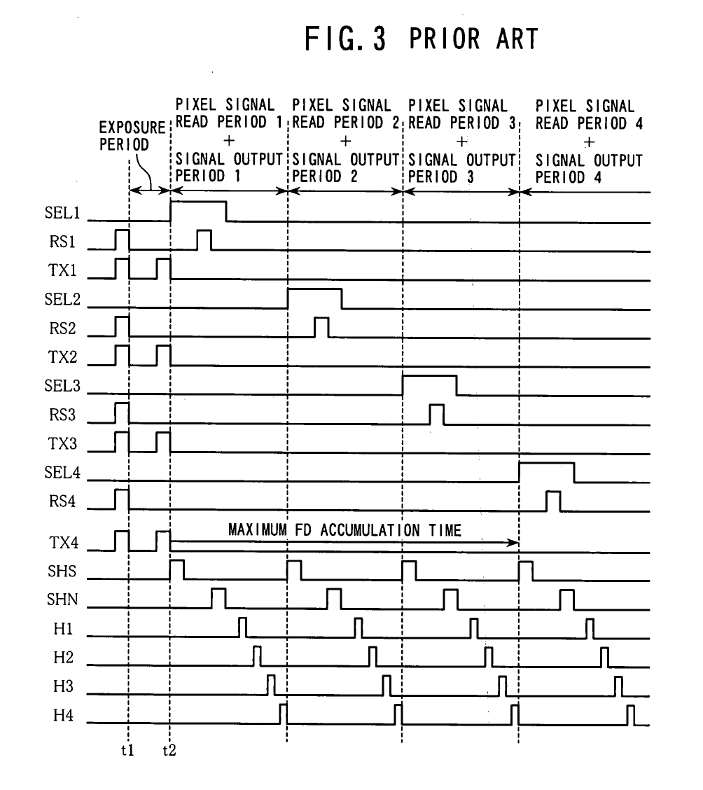

An operation of the solid-state imaging apparatus according to the first embodiment will now be described by way of a timing chart shown in FIG. 6. The operation from start to end of exposure of the pixel cells by the vertical scanning section 4 (concurrent shutter function) is similar to the prior-art example shown in FIGS. 2 and 3. In particular, at first, transfer signals TX1 to TX4 and reset signals RS1 to RS4 are driven to H level so as to effect reset operation of photodiode PD through the transfer transistor M1 and reset transistor M2 within the pixel cell 1. An exposure of photodiode PD is started from a point in time (time point t1) when the transfer signals TX1 to TX4 are subsequently returned to L level. At this time, the exposure of photodiode PD is started simultaneously of all pixel cells 1 contained in the pixel section 2.

The reset signals RS1 to RS4 are subsequently returned to L level to end reset of the floating diffusion section FD. The exposure is completed such that transfer signals TX1 to TX4 are driven to H level again to transfer electric charge accumulated at photodiode PD to the floating diffusion section FD, and the transfer signals TX1 to TX4 are subsequently brought to L level at time point t2. At this time, the exposure of photodiode PD is ended simultaneously of all pixel cells 1 contained in the pixel section 2.

Next, select signal SEL1 is driven to H level by the vertical scanning section 3 to select a first row of the pixel section so that signal component Vsig of the first pixel row is outputted to the vertical signal line 8. Here, by setting the sampling signal SH and clamping signal CL of the noise suppressing section 31 to H level by control of the control section 32, the signal component Vsig is retained at the clamp capacitor C15. At this time, an input section of the column amplifier A15 is set to the clamp voltage VCL. Subsequently, the clamping signal CL is brought to L level to bring the input section of the column amplifier A15 into a floating state.

Subsequently, reset signal RS1 is driven to H level by the vertical scanning section 3 and then the reset signal RS1 is returned to L level to reset the floating diffusion section FD. The reset signal component Vrst of the first pixel row is thereby outputted to the vertical signal line 8. Here, since the input section of the column amplifier A15 is in its floating state at the noise suppressing section 31, change (Vrst−Vsig) in pixel signal is overlapped on the basis of clamp voltage VCL. The input section of the column amplifier 15A thereby becomes [VCL+(Vrst−Vsig)]. Here, even if a threshold variance Δ Vth, which is a characteristic difference of amplification transistor M3, occurs in the pixel output, the threshold variance Δ Vth is canceled because it is contained in both the signal component Vsig and the reset component Vrst.

At this time, at the memory section 22, a memory write signal MW1 of the first row is driven to H level by the memory vertical scanning section 23 so as to accumulate an output of the noise suppressing section 31 at the memory capacitor C31 through the memory write transistor M31. Subsequently, the memory write signal MW1 and select signal SEL are brought to L level. The read and noise suppressing operation, and write operation to the memory section 22 of the pixel signals of the first row are thereby complete. In a similar manner, the read and noise suppressing operation, and write to the memory section 22 are effected of the pixel signals of the second to fourth rows.

Next, memory read signal MR1 is driven to H level by the memory vertical scanning section 23 to select the first row of the memory section so as to output memory signals of the first row. At this time, the horizontal select section 5 is selected sequentially in column direction by the horizontal scanning section 6. The memory signals retained at the memory section 22 are thereby read out to the horizontal signal line 11 through the column select transistor M25 and are outputted to the outside of the solid-state imaging apparatus through the output amplifier 12. In a similar manner, read operation is effected of the memory signals of the second to fourth rows of the memory section 22.

In the present embodiment thus, after reading the pixel signals from the pixels section 2 and effecting noise suppressing operation at the noise suppressing section 31 and write operation to the memory section 22, the memory signals of the memory section 22 are read out to the outside. For this reason, the waiting time of the pixel row to be read out last in the pixel section 2 becomes shorter so that noise component occurring at the floating diffusion section FD is smaller and image quality is improved.

### Embodiment 2

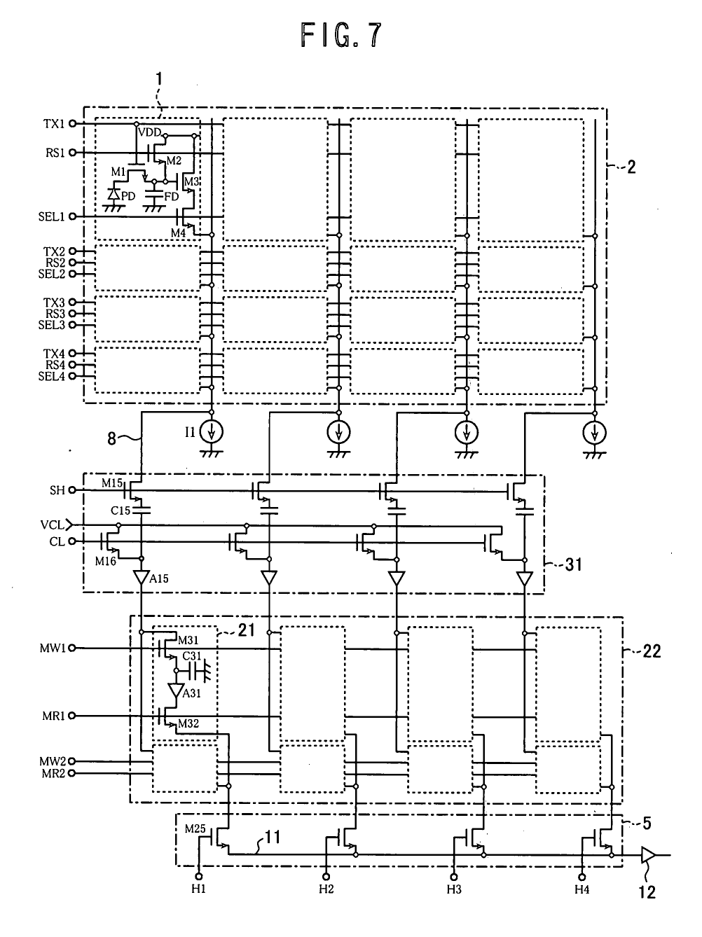

A second embodiment of the invention will now be described. FIG. 7 is a block diagram showing construction of the solid-state imaging apparatus according to the second embodiment. In the first embodiment shown in FIG. 5, the pixel section 2 has been shown as a pixel array of 4 rows by 4 columns and the memory section 22 also as an array of 4-row by 4-column memory cells 21. In the second embodiment as shown in FIG. 7, on the other hand, if the pixel section 2 is formed as a 4-row by 4-column pixel array similarly to the first embodiment, the memory section 22 is composed of memory cells 21 of 2-row by 4-column array or a half the number of pixels. Further other constructions of the second embodiment are the same as the first embodiment.

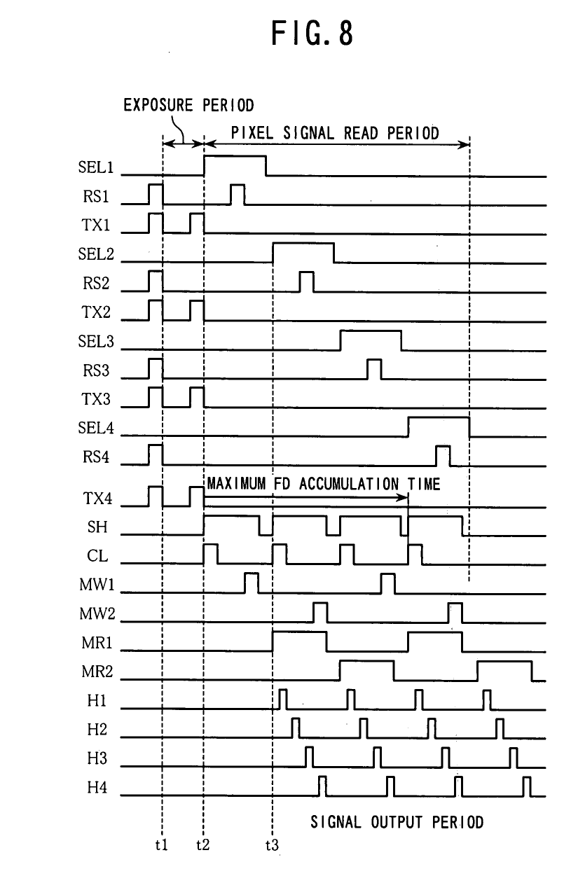

An operation of the case with a pixel array and memory cell array having such construction will now be described with reference to a timing chart shown in FIG. 8. Also in the second embodiment, the exposure operation of all pixels from time point t1 to time point t2, and operation through read of pixel signal, noise suppression, and write to the memory section 22 associated with the first pixel row as shown in the timing chart of FIG. 8 are the same as the operation of the first embodiment shown in FIG. 6.

Next, select signal SEL2 is driven to H level at time point t3 by the vertical scanning section 3 to select the second row of the pixel section 2 so that signal component Vsig of the second pixel row is outputted. At this time, by setting the sampling signal SH and clamping signal CL to H level, the signal component Vsig is retained at the clamp capacitor C15 of the noise suppressing section 31. At this time, an input section of the column amplifier A15 is set to the clamp voltage VCL. Subsequently, the clamping signal CL is brought to L level to bring the input section of the column amplifier A15 into a floating state.

Subsequently, reset signal RS2 is driven to H level by the vertical scanning section 3, and the reset signal RS2 is returned to L level again to reset the floating diffusion section FD. A reset signal component Vrst of the second pixel row is thereby outputted. Here, since the input section of the column amplifier A15 is in its floating state, change (Vrst−Vsig) in pixel signal is overlapped at the input section on the basis of clamp voltage VCL so that voltage at the input section of the column amplifier 15A becomes [VCL+(Vrst−Vsig)].

At this time, a memory write signal MW2 of a second row of the memory section 22 is driven to H level by the memory vertical scanning section 23 to accumulate an output of the noise suppressing section 31 at the memory capacitor C31 through the memory write transistor M31 of the memory cells of the second row. Subsequently, the memory write signal MW2 and select signal SEL2 are brought to L level to end the read and noise suppressing operation, and write operation to the memory section 22 of the pixel signals of the second row of the pixel section 2. Simultaneously with the start of read of pixel signals of the second row at time point t3 as described, the memory signals accumulated at the first row of the memory section 22 are read out to the outside.

In particular, the memory read signal MR1 is driven to H level at time point t3 by the memory vertical scanning section 23 so that the first row of the memory section 22 is selected and the memory signals of the first row are outputted. At this time, the horizontal select section 5 is selected sequentially in column direction by the horizontal scanning section 6 so that the memory signals retained at the first row of the memory section 22 are read out to the horizontal signal line 11 through the column select transistor M25 and are outputted to the outside through the output amplifier 12.

In a similar manner, the operation of read of pixel signals from the third row of the pixel section 2, noise suppression at the noise suppressing section 31, and write to the first row of the memory section 22 which is previously read out and is currently empty is effected simultaneously with the operation of read to the outside of the memory signals of the second pixel row currently accumulated at the second row of the memory section 22. Subsequently, the operation of read of pixel signals from the fourth row of the pixel section 2, noise suppression at the noise suppressing section 31, and write to the second row of the memory section 22 which is previously read out and is currently empty is effected simultaneously with the operation of read to the outside of the memory signals of the third pixel row currently accumulated at the first row of the memory section 22. At the end, the memory signals of the fourth pixel row currently accumulated at the second row of the memory section 22 are read out to the outside.

As the above, the present embodiment is constructed so that, during the operation of read, noise suppression at the noise suppressing section 31, and write to the memory section 22 of the pixel signals of N-th row in the pixel section 2, the memory signals of (N-1)-th row accumulated at the memory section 22 are read out to the outside. For this reason, one-to-one correspondence between the memory cells 21 and the pixel cells 1 is not required so that chip size can be made smaller by reducing the capacity of the memory section 22 (reduced to ½ in the illustrated example). Further, a total time required in outputting the pixel signals to the outside of the solid-state imaging apparatus is reduced.

### Embodiment 3

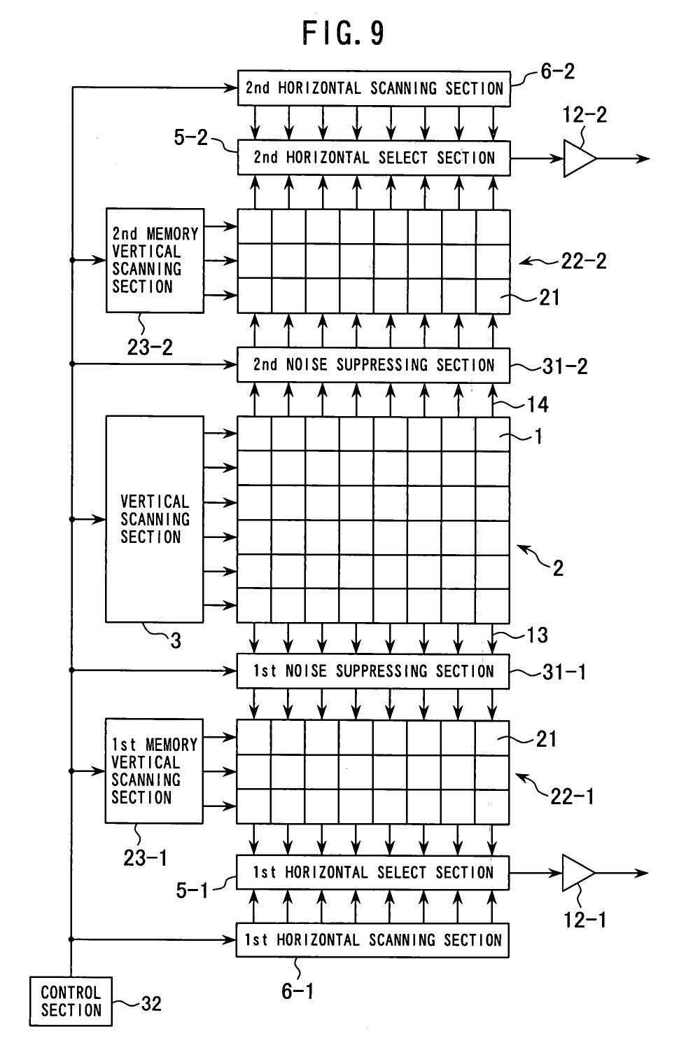

A third embodiment of the invention will now be described. FIG. 9 is a block diagram showing the solid-state imaging apparatus according to the third embodiment. In the third embodiment as shown in FIG. 9, a first and a second noise suppressing sections 31-1, 31-2, a first and a second memory sections 22-1, 22-2, a first and a second horizontal select sections 5-1, 5-2, a first and a second horizontal scanning sections 6-1, 6-2, a first and a second output amplifiers 12-1, 12-2, and a first and a second memory vertical scanning sections 23-1, 23-2 are respectively disposed on an upper and lower sides with placing the pixel section 2 between. The solid-state imaging apparatus is then constructed with providing two vertical signal lines per one column such that the pixels in odd number rows of the pixel section 2 are connected to an odd-number row vertical signal line 13 and the pixels in even number rows to an even-number row vertical signal line 14. It should be noted that the vertical scanning section 3, first and second noise suppressing section 31-1, 31-2, first and second memory vertical scanning section 23-1, 23-2, as well as first and second horizontal scanning section 6-1, 6-2 are controlled respectively in a similar manner by control signals from the control section 32.

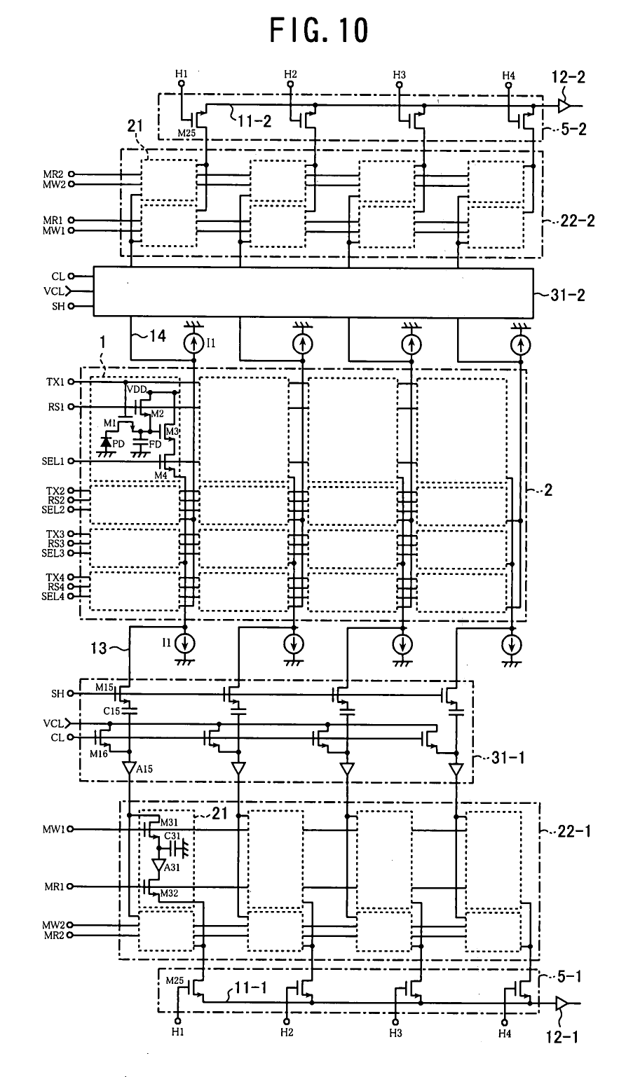

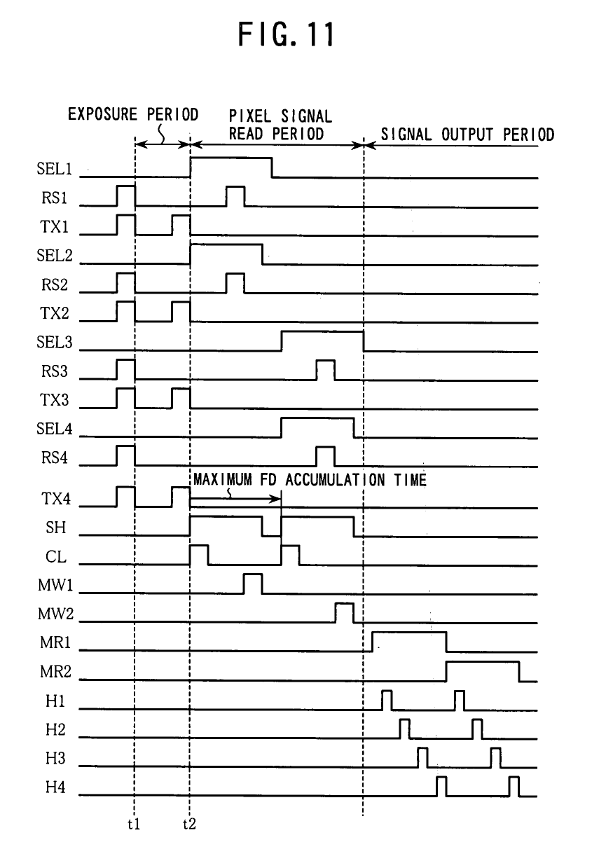

A specific construction and operation of the case where the pixel section 2 is formed as 4-row by 4-column pixel array in the solid-state imaging apparatus according to the third embodiment having the above construction will now be described by way of FIGS. 10 and 11. In the present embodiment as shown in FIG. 11, the exposure operation from start to end of the exposure of the pixel cells is identical to the first and second embodiments, but the following points are different. In the present embodiment, the reading operation of pixel signals, noise suppression operation, and writing operation to the memory section 22 of two rows are effected simultaneously, and two rows of the memory signals of the memory section 22 are simultaneously read out to the outside. In particular, select signals SEL1 and SEL2 are driven to H level by the vertical scanning section 3 to simultaneously select the first row and the second row of the pixel section 2. The pixel signals of the first row are then written to a first row of the first memory section 22-1 by a memory write signal MW1 from the first memory vertical scanning section 23-1 through the first noise suppressing section 31-1 which is disposed on the lower side. The pixel signals of the second row, on the other hand, are written to a first row of the second memory section 22-2 by a memory write signal MW1 from the second memory vertical scanning section 23-2 through the second noise suppressing section 31-2 which is disposed on the upper side.

Subsequently, select signals SEL3 and SEL4 are driven to H level by the vertical scanning section 3 to simultaneously sect the third and the fourth rows of the pixel section 2. The pixel signals of the third row are then written to a second row of the first memory section 22-1 through the first noise suppressing section 31-1 which is disposed on the lower side, and the pixel signals of the fourth row are written to a second row of the second memory section 22-2 through the second noise suppressing section 31-2 which is disposed on the upper side.

Simultaneously at this time, memory read signal MR1 is driven to H level at the first and the second memory vertical scanning section 23-1, 23-2 disposed on the upper and lower sides so that the first rows respectively of the first and the second memory sections 22-1, 22-2 on the upper and lower sides are selected and are respectively caused to output the memory signals of the first row. Here, the first and the second horizontal select section 5-1, 5-2 are selected sequentially in column direction by the first and the second horizontal scanning section 6-1, 6-2. The memory signals of the first rows respectively retained at the first and the second memory sections 22-1, 22-2 are thereby respectively read out to the first and the second horizontal signal lines 11-1, 11-2 through the column select transistor M25 and are respectively outputted to the outside through the first and the second output amplifiers 12-1, 12-2. At the end, memory read signal MR2 is driven to H level at the first and the second memory vertical scanning section 23-1, 23-2 disposed on the upper and lower sides so that the second rows of the first and the second memory sections 22-1, 22-2 on the upper and lower sides are selected, and the memory signals of the second rows of the first and the second memory sections 22-1, 22-2 are read out to the outside.

In the present embodiment, thus, two units each of the noise suppressing section, memory section, horizontal select section, and output amplifier are disposed on the upper and lower sides with placing the pixel section 2 between. The pixel signals of two rows are then simultaneously read out from the pixel section 2 with using the odd-number row vertical signal line 13 and the even-number row vertical signal line 14, and the pixel signals of two rows are simultaneously subjected to noise suppressing operation at the noise suppressing sections disposed on the upper and lower sides of the pixel section 2 and are written to the memory sections disposed on the upper and lower sides of the pixel section 2. By reading the memory signals of the memory sections disposed on the upper and lower sides of the pixel section 2 to the outside of the solid-state imaging apparatus, the waiting time of the pixel row to be read out at the end becomes ½ as compared to one in which read operation is effected row by row. It is thereby possible to restrain noise components occurring at the floating diffusion section FD to a lower level so as to improve image quality. Further, a total time in outputting the pixel signals to the outside of the solid-state imaging apparatus is also reduced.

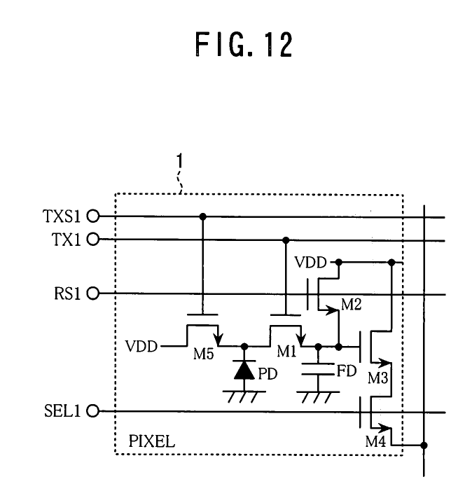

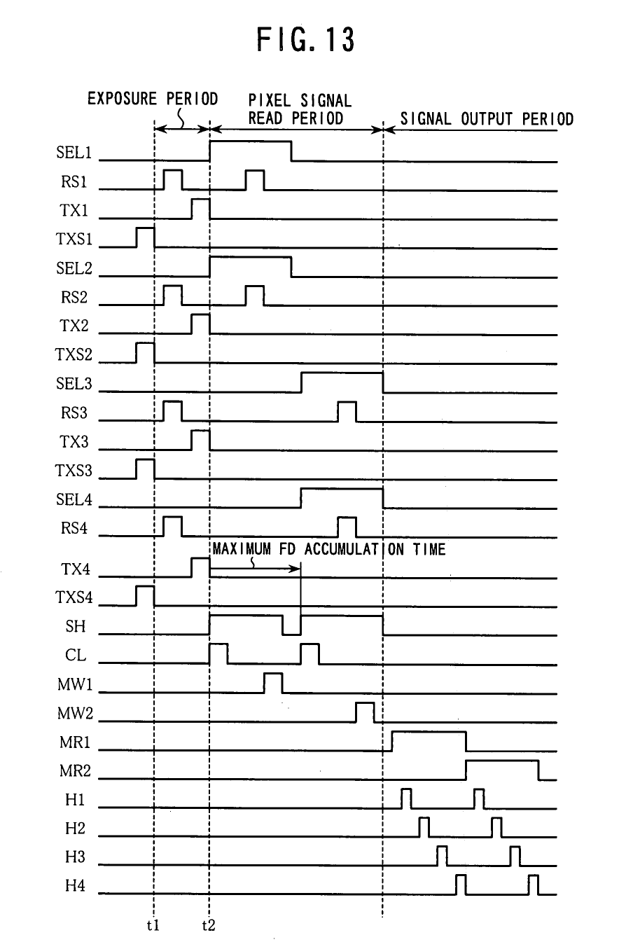

It should be noted that constructions other than those illustrated in the figures may also suitably be used as the pixel cell, noise suppressing section, and memory cell shown in the above embodiments. For example, a pixel cell to which a shutter transistor M5 is added as shown in FIG. 12 may also be suitably used. In this case, as shown in the timing chart of FIG. 13, photodiodes PD of all pixel cells can be reset by driving shutter signals TXS1 to TXS4 to H level. Here, the point in time (time point t1) when the shutter signals TXS1 to TXS4 are set to L level is the start of electric charge accumulation to photodiodes PD (start of exposure).

Furthermore, in the above embodiments, it is preferable to cover the entire region of the memory section with a metal wiring layer to completely shield the memory section from light. By shielding the memory section from light in this manner, an effect due to an incident light to the memory section while holding a signal can be suppressed.

As has been described by way of the above embodiments, a memory section is provided according to the first and second aspects of the invention so that, after concurrently transferring signal charges at each pixel cell of the pixel section to an input terminal of the amplification means, the reading of signals from the pixel section and signal processing at the column signal processing circuit are effected line by line to effect a high-speed transfer to the memory section, and then the signals are read out from the memory section to its outside. The waiting time (charge retaining period) of the pixel line to be read out at the end in the pixel section is thereby reduced so that dark current occurring at the input terminal (FD section) of the amplification means of the pixel cell as well as noise component due to leakage light can be reduced to improve image quality.

According to the third aspect, the occurrence of dark current as well as noise component due to leakage light can be similarly reduced to improve image quality in a memory section having a smaller capacity, and an increase in chip area due to the disposition of the memory section can be restricted.

According to the fourth aspect, the memory section is composed of the first and the second memory sections so that signals read out from the pixel section and processed line by line are transferred simultaneously to the first and the second memory sections. The waiting time for read (charge retaining period) in the pixel section is thereby further reduced so that an effect of dark current and leakage light can be further restricted to achieve a further improvement in image quality.

According to the fifth aspect, the memory section can be completely shielded from light so that an effect of an incident light to the memory section during holding signals can be suppressed.

What is claimed is:

1. A solid-state imaging apparatus comprising:
a pixel section having a plurality of pixel cells that are two-dimensionally arrayed, each having a photoelectric conversion section for generating signal electric charge corresponding to an object image, an electric charge transfer means for transferring the signal electric charge generated at the photoelectric conversion section, an amplification means for receiving at an input terminal thereof the electric charge transferred from said photoelectric conversion section by the electric charge transfer means and outputting a signal corresponding to the number of the electric charge at the input terminal, and a reset means for resetting the input terminal of the amplification means, where an output of said amplification means becoming an output signal of said pixel cell;
a vertical signal line to which the output signal of said pixel cell is read out;
a column signal processing circuit connected to the vertical signal line so as to effect an analog signal processing on the output signal of said pixel cell;
a memory section for, during signal processing by said column signal processing circuit of the pixel cells associated with a first line of said pixel section, storing signal processing results of the pixel cells associated with a second line of which signal processing by said column signal processing circuit is executed previous to said first line; and
a control section for rendering control so that, after causing said reset means of each pixel cell of said pixel section to simultaneously operate, signal electric charges generated at said photoelectric conversion section of each pixel cell are transferred simultaneously of all pixels to the input terminal of said amplification means by said electric charge transfer means, output signals of said amplification means are then sequentially outputted line by line of said pixel section to said vertical signal line, and the signal processing at said column signal processing circuit and a transfer to said memory section are then effected of the output signals to said vertical signal line, and for rendering control of a readout from said memory section to an external device.

2. The solid-state imaging apparatus according to claim 1, wherein said memory section has a capacity substantially equal to the number of all pixel cells of said pixel section.

3. The solid-state imaging apparatus according to claim 1, wherein said memory section has a capacity smaller than the number of all pixel cells of said pixel section, and said control section renders control so that a storing operation of the signal processing results associated with the first line to said memory section from said column processing circuit and a readout operation associated with the second line from said memory section to the external device are effected in parallel.

4. The solid-state imaging apparatus according to claim 1, wherein said memory section comprises a first memory section disposed on one side of said pixel section and a second memory section disposed on the other side in a manner placing said pixel section between;
wherein said vertical signal line comprises a first vertical signal line to which the pixel cells of first pixel rows of said pixel section are connected and a second vertical signal line to which the pixel cells of second pixel rows of said pixel section different from said first pixel rows are connected;
wherein said column signal processing circuit comprises a first column signal processing circuit connected between said first vertical signal line and said first memory section, and a second column signal processing circuit connected between said second vertical signal line and said second memory section; and
wherein said control section renders control so that the output signals from said pixel section are read out line by line simultaneously to said first and said second vertical signal lines, are processed at said first and said second column signal processing circuits, and are transferred line by line simultaneously to said first and said second memory sections.

5. The solid-state imaging apparatus according to claim 1, wherein said memory section is covered with a metal wiring layer over an entire region thereof.
